(19) United States
(12) Patent Application Publication
(10) Pub. No.: US 2014/0010989 A1
(43) Pub. Date: Jan. 9, 2014

(54) Board Stock

(71) Applicant: CMC Group, Inc., Bowling Green, OH (US)

(72) Inventors: Robert W. Piefke, Beavercreek, OH (US); Gregory L. Rogers, Portage, OH (US)

(21) Appl. No.: 13/934,276

(22) Filed: Jul. 3, 2013

Related U.S. Application Data
(60) Provisional application No. 61/668,619, filed on Jul. 6, 2012.

(51) Int. Cl. B32B 29/00

(52) U.S. Cl. CPC B32B 29/005
USPC 428/99; 428/537.5; 428/220; 162/100

(57) ABSTRACT

Board stock that includes, among other things, multiple layers of degradable paper secured together by a degradable adhesive. In an embodiment, the board stock can be made of multiple layers of water soluble paper secured together by a water soluble adhesive. In another embodiment, the board stock includes a single layer of degradable material, such as water soluble paper, having an increased thickness. In other embodiments, the board stock can be used to make a wide-variety of articles.

### CROSS-REFERENCE TO RELATED APPLICATION

This claims priority to and the benefit of U.S. Provisional Patent Application No. 61/668,619, filed on Jul. 6, 2012, which is incorporated herein by reference.

### BACKGROUND OF THE INVENTION

This invention relates generally to board stock. More specifically, this invention relates to degradable board stock.

Board stock is used for many purposes. For example, it can be used to make packaging containers, hang tags, stationery products, and other articles. Board stock typically includes multiple layers of paper material that are laminated or otherwise secured together by an adhesive to form a relatively strong, lightweight structure. Advantageously, board stock can be provided in a wide-range of thicknesses and densities.

Although it is known to make board stock from recyclable materials, there is the possibility that many articles made from recyclable board stock are disposed of in a general trash receptacle. As a result, it likely that these articles will not be properly recycled. Further, the recycling of paper products can be costly and typically consumes additional resources. Thus, it is desirable to provide environmentally-friendly board stock that is made entirely from degradable materials such as those that can be easily dissolved or dispersed in a liquid such as water.

### SUMMARY OF THE INVENTION

This invention is degradable board stock. In one embodiment, the board stock includes, among other things, multiple layers of degradable paper secured together by a degradable adhesive. For example, the board stock can be made of multiple layers of water soluble paper secured together by a water soluble adhesive. In another embodiment, the board stock includes a single layer of degradable material, such as water soluble paper, having an increased thickness. In other embodiments, the board stock can be used to make a wide-variety of articles.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a cross-sectional view of a first embodiment of board stock in accordance with this invention.

FIG. 2 is a cross-sectional view of a second embodiment of board stock in accordance with this invention.

FIG. 3 is a cross-sectional view of a third embodiment of board stock in accordance with this invention.

FIG. 4 is a front elevational view of a hang tag made from the board stock as shown in either FIG. 1, 2, or 3, in accordance with a fourth embodiment of this invention.

FIG. 5 is a cross-sectional view of a fifth embodiment of board stock in accordance with this invention.

FIG. 6 is a cross-sectional view of a sixth embodiment of board stock in accordance with this invention.

FIG. 7 is a front elevational view of a hang tag made from the board stock as shown in either FIG. 5 or 6, in accordance with a seventh embodiment of this invention.

### DETAILED DESCRIPTION OF THE INVENTION

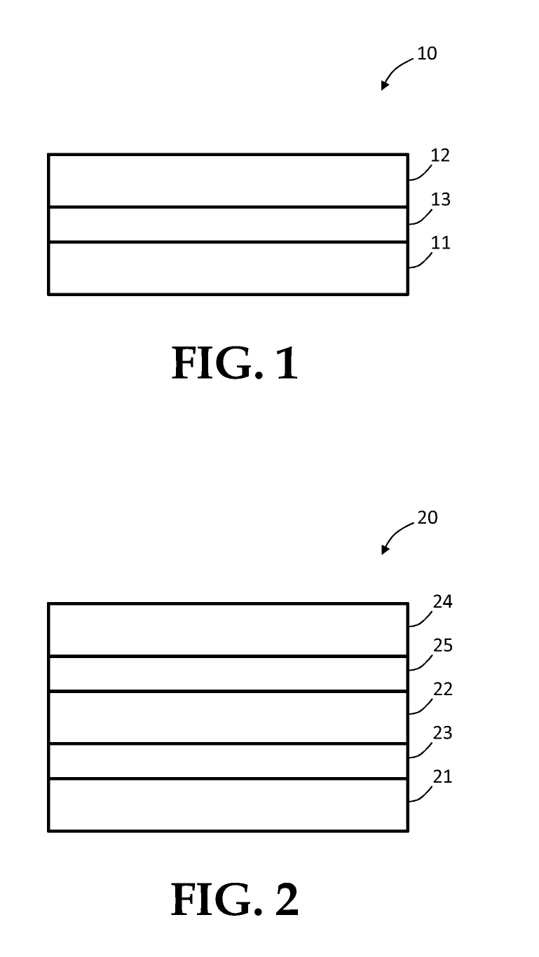

Referring now to the drawings, there is illustrated in FIG. 1 a sheet of board stock, indicated generally at 10, in accordance with a first embodiment of this invention. As will be explained below, the board stock 10 can be used in a wide-variety of industries, for example, to make packaging containers, hang tags, stationery products, and any other articles. It should be appreciated, however, that the board stock 10 can be used in any desired environment and for any desired purpose.

The illustrated board stock 10 includes a first layer of degradable paper 11 and a second layer of degradable paper 12 that is secured together by a layer of degradable adhesive 13. The first and second layers of degradable paper 11, 12 can be made from any paper that is configured to break down or otherwise decompose when exposed to natural occurring elements over a period of time. In one non-limiting example, the first and second layers of degradable paper 11, 12 can be a water soluble or water dispersible paper that readily dissolves or disperses when brought into contact with a liquid such as water. It should be fully appreciated that the first and second layers of degradable paper 11, 12 can have any desired thickness or density for an intended use.

The layer of degradable adhesive 13 can be any composition that is configured to break down or otherwise decompose when exposed to natural occurring elements over a period of time. In one non-limiting example, the layer of degradable adhesive 13 can be a water soluble or water dispersible adhesive that readily dissolves or disperses when brought into contact with a liquid such as water.

Referring now to FIG. 2, there is illustrated a second embodiment of a sheet of board stock, indicated generally at 20, in accordance with this invention. The illustrated board stock 20 is, in large measure, similar to the board stock 10 described above in the first embodiment. As such, similar elements have been numbered with common reference numerals but have been increased by a quantity of 10 (e.g. 20, 21, 22, 23). It should be appreciated that similar elements are structured similarly, operate similarly, and/or have the same function unless otherwise indicated by the drawings or this specification.

As shown, the board stock 20 includes a first layer of degradable paper 21 and a second layer of degradable paper 22 that are secured together by a first layer of degradable adhesive 23. A third layer of degradable paper 24 is secured to the second layer of degradable paper 22 by a second layer of degradable adhesive 25. The respective layers of degradable paper 21, 22, and 24 can be any water soluble or water dispersible paper, for example, as described above. Similarly, the respective layers of degradable adhesive 23, 25 can be any water soluble or water dispersible adhesive, for example, as described above. Thus, it should be fully appreciated that the board stock 20 may include any number of degradable paper layers secured together by any number of degradable adhesive layers to achieve a desired thickness and density.

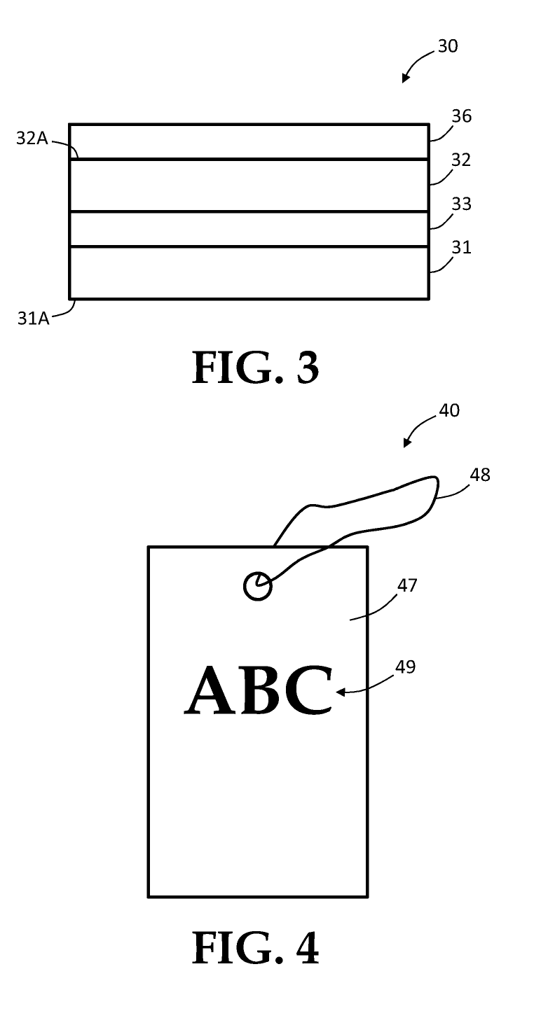

Referring now to FIG. 3, there is illustrated a third embodiment of a sheet of board stock, indicated generally at 30, in accordance with this invention. The illustrated board stock 30 is, in large measure, similar to the board stock 10 described above in the first embodiment. As such, similar elements have been numbered with common reference numerals but have been increased by a quantity of 20 (e.g. 30, 31, 32, 33). It should be appreciated that similar elements are structured similarly, operate similarly, and/or have the same function unless otherwise indicated by the drawings or this specification.

As shown, the board stock 30 includes a first layer of degradable paper 31 and a second layer of degradable paper 32 that are secured together by a layer of degradable adhesive 33. The first and second layers of degradable paper 31, 32 can be any water soluble or water dispersible paper, for example, as described above. Similarly, the layer of degradable adhesive 33 can be any water soluble or water dispersible adhesive, for example, as described above. It should be fully appreciated that the board stock 30 may include any number of degradable paper layers secured together by any number of degradable adhesive layers to achieve a desired thickness and density.

The illustrated board stock 30 further includes a degradable coating 36. As shown, the degradable coating 36 is provided on an external surface 32A of the second layer of degradable paper 32. Alternatively or in addition, the degradable coating 36 can be provided on an external surface 31A of the first layer of degradable paper 31, if desired (not shown). The degradable coating 36 can be any composition or layer of material that is configured to perform a desired function. In one example, the degradable coating 36 can be a detergent or cleaning agent, the purpose of which will be explained below. In this example, the detergent may be coated on the external surface 32A of the second layer of degradable paper 32 using any suitable methods or processes. Alternatively, the detergent can be embedded into the fibers of the second layer of degradable paper 32 using any suitable methods or processes. In another example, the degradable coating 36 can be a printable layer. The printable layer enables the board stock 30 to receive printed images using any printing methods or processes, such as gravure printing, offset printing, or direct thermal printing. As such, the board stock 30 can be printed on without degrading the respective layers of degradable paper 31, 32. It should be fully appreciated that the board stock 30 can include any number or configuration of degradable coatings 36.

Referring now to FIG. 4, there is illustrated a hang tag, indicated generally at 40, in accordance with a fourth embodiment of this invention. The hang tag 40 includes a body portion 47 that can be made from one of the board stocks 10, 20, or 30 as described above. However, the body portion 47 of the hang tag 40 can alternatively be made from any other degradable material that is, preferably, readily dissolvable or dispersible in water. It should also be appreciated that the body portion 47 can have any shape or dimensions for an intended use.

The illustrated hang tag 40 includes a fastening device 48 that is attached to the body portion 47. The fastening device 48 can be configured in any manner to fasten or otherwise support the body portion 47 from an article, such as clothing or any other suitable item. The illustrated fastening device 48 is a flexible tether, such as a string or the like, which is looped through a hole formed in the body portion 47 of the hang tag 40. Alternatively, the fastening device 48 can be attached to the body portion 47 in any other manner. Further, it should be appreciated that the fastening device 48 can have any length or thickness for an intended use.

The fastening device 48 can be made from any material that is configured to degrade when exposed to natural occurring elements over a period of time. In one non-limiting example, the fastening device 48 can be a water soluble or water dispersible material that readily dissolves or disperses when brought into contact with a liquid such as water. More specifically, the fastening device 48 can be formed from a thin-grade water soluble paper.

The illustrated hang tag 40 also includes indicia 49 provided on the body portion 47 thereof. The indicia 49 can be a trademark, logo, illustration, advertisement, product information, or any other desired marking The indicia 49 can be provided on a single side or both sides of the body portion 47, as desired. Further, it should be appreciated that the indicia 49 can be printed on the body portion 47 using any suitable printing method or process.

The illustrated hang tag 40 is advantageous in that both the body portion 47 and the fastening device 48 are readily soluble in water. This can help to reduce the amount of waste that is accumulated in landfills. For example, the hang tag 40 can be placed in a conventional washing machine along with the article to which it is attached. The hang tag 40 completely dissolves without damaging the machine or clogging associated drain pipes. Further, the hang tag 40 can be made from the board stock 30, as described above, which may include a detergent that acts as a cleaning agent.

In addition to hang tags 40, the board stock 10, 20, and 30 as described above can be used to make packaging containers, stationery products, or any other suitable article. As such, these articles would be degradable and, more preferably, easily dissolvable or dispersible in a liquid such as water.

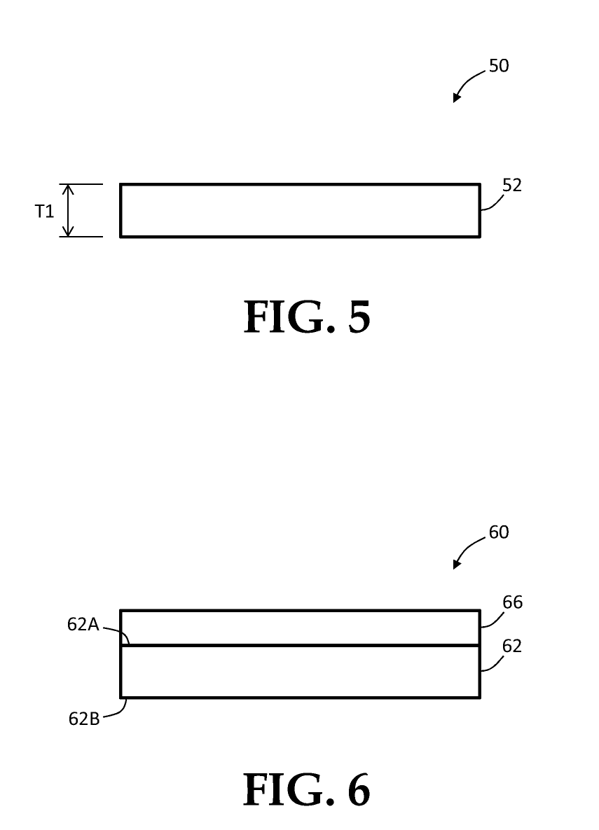

Referring now to FIG. 5, there is illustrated a sheet of board stock, indicated generally at 50, in accordance with a fifth embodiment of this invention. The illustrated board stock 50 includes a single layer of degradable paper 52. The single layer of degradable paper 52 can be any water soluble or water dispersible paper, for example, as described above in the previous embodiments. However, the illustrated single layer of degradable paper 52 has a predetermined thickness T1 that is thicker than conventional water soluble or water dispersible paper. In one example, the single layer of degradable paper 52 can have a thickness T1 in the range of approximately 10 to 50 mils. In another example, the single layer of degradable paper 52 can have a thickness T1 in the range of approximately 10 to 25 mils. In yet another example, the single layer of degradable paper 52 can have a thickness T1 in the range of approximately 25 to 50 mils. It should be fully appreciated that the single layer of degradable paper 52 can have any thickness T1 for a desired use, and is not limited to the ranges provided herein. The single layer of degradable paper 52 eliminates the need to laminate multiple layers of relatively thinner degradable paper together using degradable adhesive, as described above in the previous embodiments.

Referring now to FIG. 6, there is illustrated a sixth embodiment of a sheet of board stock, indicated generally at 60, in accordance with this invention. The illustrated board stock 60 is, in large measure, similar to the board stock 50 described above in the previous embodiment. For example, the board stock 60 includes a single layer of degradable paper 62. The single layer of degradable paper 62 can be any water soluble or water dispersible paper having a thickness, for example, as described above in the previous embodiment. However, the board stock 60 further includes a degradable coating 66. The illustrated degradable coating 66 is provided on a first surface 62A of the single layer of degradable paper 62. Alternatively or in addition, the degradable coating 66 can be provided on a second or opposite surface 62B of the single layer of degradable paper 62, if desired (not shown). The degradable coating 66 can be any composition or layer of material that is configured to perform a desired function. For example, the degradable coating 66 can be a detergent or a printable layer, as described above in the third embodiment. It should be fully appreciated that the board stock 60 can include any number or configuration of degradable coatings 66.

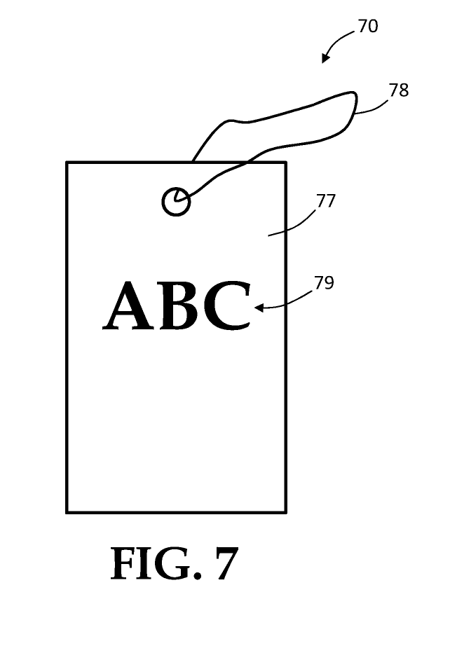

Referring now to FIG. 7, there is illustrated a hang tag, indicated generally at 70, in accordance with a seventh embodiment of this invention. The illustrated hang tag 70 is, in large measure, similar to the hang tag 40 described above in the fourth embodiment. As such, similar elements have been numbered with common reference numerals but have been increased by a quantity of 30 (e.g. 70, 71, 72, 73). It should be appreciated that similar elements are structured similarly, operate similarly, and/or have the same function unless otherwise indicated by the drawings or this specification.

For example, the illustrated hang tag 70 includes a body portion 77. The body portion 77 may, however, be made from one of the board stocks 50 or 60 as described above. The illustrated hang tag 70 also includes a fastening device 78 that is attached to the body portion 77. The fastening device 78 can be a flexible tether, such as a string or the like, which is looped through a hole formed in the body portion 77 of the hang tag 70. The fastening device 78 can be made from any material that is configured to degrade when exposed to natural occurring elements over a period of time, such as a water soluble or water dispersible material. The illustrated hang tag 70 also includes indicia 79 provided on the body portion 77 thereof. The indicia 79 can be a trademark, logo, illustration, advertisement, product information, or any other desired marking as described above in the fourth embodiment.

In addition to hang tags 70, the board stock 50 and 60 as described above can be used to make packaging containers, stationery products, or any other suitable article. As such, these articles would be degradable and, more preferably, easily dissolvable or dispersible in a liquid such as water.

The principle and mode of operation of this invention have been explained and illustrated in its preferred embodiments. However, it must be understood that this invention may be practiced otherwise than as specifically explained and illustrated without departing from its spirit or scope.

What is claimed is:

1. Board stock comprising:
a first layer of degradable material and a second layer of degradable material; and
a degradable adhesive securing together the first and second layers of degradable material.

2. The board stock of claim 1, wherein the first and second layers of degradable material are a water soluble paper.

3. The board stock of claim 1, wherein the degradable adhesive is a water soluble adhesive.

4. The board stock of claim 1 further including a degradable coating applied to at least one of the first and second layers of degradable material.

5. The board stock of claim 1 further including a degradable fastening device.

6. Board stock comprising:
a first layer of water soluble paper and a second layer of water soluble paper; and
a water soluble adhesive securing together the first and second layers of water soluble paper.

7. The board stock of claim 1 further including a water soluble fastening device attached thereto.

8. A hang tag comprising:
a body portion including a first layer of degradable material and a second layer of degradable material secured together by a degradable adhesive; and
a degradable fastening device attached to the body portion.

9. The hang tag of claim 8, wherein the first and second layers of degradable material are a water soluble paper and the degradable adhesive is a water soluble adhesive.

10. The hang tag of claim 8, wherein the fastening device is water soluble.

11. Board stock comprising:
a single layer of degradable material.

12. Board stock comprising:
a single layer of degradable material having a predetermined thickness.

13. The board stock of claim 12, wherein the single layer of degradable material is water soluble paper.

14. The board stock of claim 12, wherein the single layer of degradable material has a thickness in the range of approximately 10 to 50 mils.

15. The board stock of claim 12 further including a degradable coating applied to at least one surface of the single layer of degradable paper.

16. The board stock of claim 12 further including a degradable fastening device attached thereto.

17. A hang tag comprising:
a body portion being made from a single layer of degradable material; and
a degradable fastening device attached to the body portion.

18. The hang tag of claim 17, wherein the single layer of degradable material is a water soluble paper.

19. The hang tag of claim 17, wherein the degradable fastening device is water soluble.

20. The hang tag of claim 17 further including a degradable coating applied to at least one surface of the single layer of degradable material.
